(19) United States
(12) Patent Application Publication
(10) Pub. No.: US 2019/0305657 A1
(43) Pub. Date: Oct. 3, 2019

(54) MOTOR AND MANUFACTURING METHOD OF MOTOR

(71) Applicant: NIDEC SANKYO CORPORATION, Suwan-gun (JP)

(72) Inventors: Hiroshige SUGURO, Suwa-gun (JP); Takanori OHKAWA, Suwa-gun (JP); Osamu KODAIRA, Suwa-gun (JP)

(21) Appl. No.: 16/354,634

(22) Filed: Mar. 15, 2019

(30) Foreign Application Priority Data
Mar. 30, 2018 (JP) 2018-067957

(51) Int. Cl. H02K 15/14; H02K 5/10; H02K 5/173

(52) U.S. Cl. CPC H02K 15/14; H02K 5/173; H02K 5/10

(57) ABSTRACT

A motor may include a motor case, a terminal block holding terminal pins, a cover and a sealing resin body. The terminal pin may include a first end part for connecting with a coil wire and a second end part for connecting with an outside. A cover is disposed so as to cover the first end part and closes an opening part of the motor case together with the terminal block. A sealing resin body is provided so as to cover the terminal block, the cover and a side face of the motor case. A seal member is attached to each of the terminal pins protruded from the terminal block on the second end part side between the terminal block and a wall face from which the second end part is protruded, and the seal member seals between the terminal pins and the sealing resin body.

### CROSS REFERENCE TO RELATED APPLICATION

The present application claims priority under 35 U.S.C. § 119 to Japanese Application No. 2018-067957 filed Mar. 30, 2018, the entire content of which is incorporated herein by reference.

### TECHNICAL FIELD

At least an embodiment of the present invention may relate to a motor structured to seal an opening part of a motor case which covers a rotor and a stator and to a manufacturing method of the motor.

### BACKGROUND

A motor structured to enhance airtightness of a motor case covering a rotor and a stator has been proposed in which, in a state that an opening part of the motor case is closed by a terminal block which holds terminal pins in its grooves and a cover which covers the terminal pins, resin molding is performed to provide a sealing resin body which covers the terminal block, the cover and a side face of the motor case (see Japanese Patent Laid-Open No. 2008-113495 (Patent Literature 1)). One end part (first end part) of the terminal pin protruded from the terminal block is connected with a coil wire, and the other end part (second end part) protruded from the terminal block is used for being electrically connected with the outside. Therefore, the second end part is protruded from a wall face of the sealing resin body.

In the motor described in Patent Literature 1, entering of moisture into an inner side of the motor case is restrained by the sealing resin body. On the other hand, when presence/absence of a leak is tested by using a gas in order to further strictly evaluate sealability, a result is obtained in the motor described in Patent Literature 1 that a leak of a gas may be occurred by passing through between the sealing resin body and the terminal pin.

### SUMMARY

In view of the problem described above, at least an embodiment of the present invention provides a motor in which airtightness around the terminal pin is enhanced and a manufacturing method of the motor.

To achieve the above, at least an embodiment of the present invention provides a motor including a rotor, a stator facing the rotor, a motor case which covers the rotor and the stator and is provided with an end plate part at an end part on one side in an axial direction, a terminal block disposed on the other side in the axial direction of the motor case, a plurality of terminal pins which are extended in a direction intersecting the axial direction, each of the terminal pins being provided with a first end part for connecting with a coil wire at one end and a second end part for connecting with the outside at the other end, and the first end part and the second end part being protruded from the terminal block, a cover which is disposed so as to cover the first end part and closes an opening part of the motor case which opens on the other side in the axial direction together with the terminal block, a sealing resin body which is provided so as to cover the terminal block and the cover from the other side in the axial direction and cover a side face of the motor case, and the sealing resin body being provided with a wall face from which the second end part is protruded, and a seal member which is attached to a portion of each of the terminal pins protruded from the terminal block on a side of the second end part between the terminal block and the wall face, and the seal member seals between the plurality of the terminal pins and the sealing resin body.

In at least an embodiment of the present invention, an opening part of the motor case is closed by the terminal block holding the terminal pins and the cover which covers the first end parts of the terminal pins and, in addition, the sealing resin body which covers the terminal block, the cover and a side face of the motor case is provided. Therefore, entering of moisture into an inner side of the motor case can be restrained. Further, a seal member is attached to a portion of each of the terminal pins which is protruded from the terminal block on a side of the second end part between the terminal block and the wall face, and the seal member seals between the plurality of the terminal pins and the sealing resin body. Therefore, high airtightness between the terminal pins and the sealing resin body is attained and thus, entering of moisture into an inner side of the motor case from the opening part and the like through spaces between the terminal pins and the sealing resin body can be surely restrained.

In at least an embodiment of the present invention, the seal member is structured so that a plurality of seal parts respectively attached to the plurality of the terminal pins is connected with each other. According to this structure, spaces between a plurality of the terminal pins and the sealing resin body are sealed by one seal member and thus, the cost can be reduced.

In at least an embodiment of the present invention, the seal member has elasticity. In at least an embodiment of the present invention, the seal member is, for example, made of rubber. According to this structure, adhesiveness of the seal member to the terminal pins is high and thus, high airtightness is attained between the sealing resin body and the terminal pins.

In at least an embodiment of the present invention, the seal member is structured so that, when the seal member is taken off from the terminal pin, a size of a hole into which the terminal pin is fitted is smaller than a thickness of the terminal pin. According to this structure, adhesiveness between the terminal pin and the seal member is high and thus, high airtightness is attained between the sealing resin body and the terminal pins.

In at least an embodiment of the present invention, the seal member is buried in an inside of the sealing resin body. According to this structure, when the sealing resin body is to be formed, a pressure is applied to the seal member. Therefore, adhesiveness between the terminal pin and the seal member and adhesiveness between the seal member and the sealing resin body are high and thus, high airtightness is attained between the sealing resin body and the terminal pin.

In at least an embodiment of the present invention, the whole of the seal member is buried in the inside of the sealing resin body. According to this structure, when the sealing resin body is to be formed, a pressure is applied to the entire seal member. Therefore, adhesiveness between the terminal pin and the seal member and adhesiveness between the seal member and the sealing resin body are high and thus, high airtightness is attained between the sealing resin body and the terminal pin.

In at least an embodiment of the present invention, the terminal block is formed with a plurality of grooves each of which holds each of the terminal pins on an inner side of the groove on a face on the other side in the axial direction, the cover covers a part of a portion of each of the terminal pins located in the groove from the other side in the axial direction, and the sealing resin body covers a remaining part of the portion of each of the terminal pins located in the groove from the other side in the axial direction. According to this structure, the terminal pin in the groove is sealed by the sealing resin body and thus, entering of moisture into an inner side of the motor case through the opening part by passing around the terminal pin can be surely restrained.

In at least an embodiment of the present invention, the portion of the terminal pin located in the groove is formed with a crushed part. According to this structure, a portion of the terminal pin which is partly projected when a crushing work is performed is bitten into an inner face of the groove. Therefore, the terminal pin can be temporarily fixed to an inside of the groove.

In a manufacturing method of the motor in accordance with at least an embodiment of the present invention, after the motor case, the terminal pins and the cover are attached to the terminal block, in a step for forming the sealing resin body, resin molding is performed in a state that the seal member is attached to the portion of each of the terminal pins which is protruded from the terminal block on the side of the second end part and thereby the sealing resin body is formed.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view showing a motor in accordance with at least an embodiment of the present invention.

FIG. 2 is a front view showing the motor in FIG. 1 which is viewed in a direction that terminal pins are protruded.

FIG. 3 is an exploded perspective view showing the motor in FIG. 1.

FIG. 4 is a cross-sectional view showing the motor in FIG. 1.

FIG. 5 is an explanatory view showing a terminal block and the like shown in FIG. 4 which are viewed from the other side in an axial line “L” direction.

FIG. 6 is a cross-sectional view showing a terminal block and the like shown in FIG. 4 which are cut along a terminal pin.

FIG. 7 is a front view showing the terminal block and the like shown in FIG. 4 which are viewed from a side of a second end part of a terminal pin.

FIG. 8 is an explanatory view showing a seal member which is used in the motor shown in FIG. 1.

FIG. 9 is an explanatory view when a position of a seal member is changed in the motor shown in FIG. 1.

FIG. 10 is an explanatory view showing a first modified example of a terminal pin which is used in the motor shown in FIG. 1.

FIG. 11 is an explanatory view showing a second modified example of a terminal pin which is used in the motor shown in FIG. 1.

FIG. 12 is an explanatory view showing a third modified example of a terminal pin which is used in the motor shown in FIG. 1.

### DETAILED DESCRIPTION

At least an embodiment of the present invention will be described below with reference to the accompanying drawings.

### Entire Structure of Motor

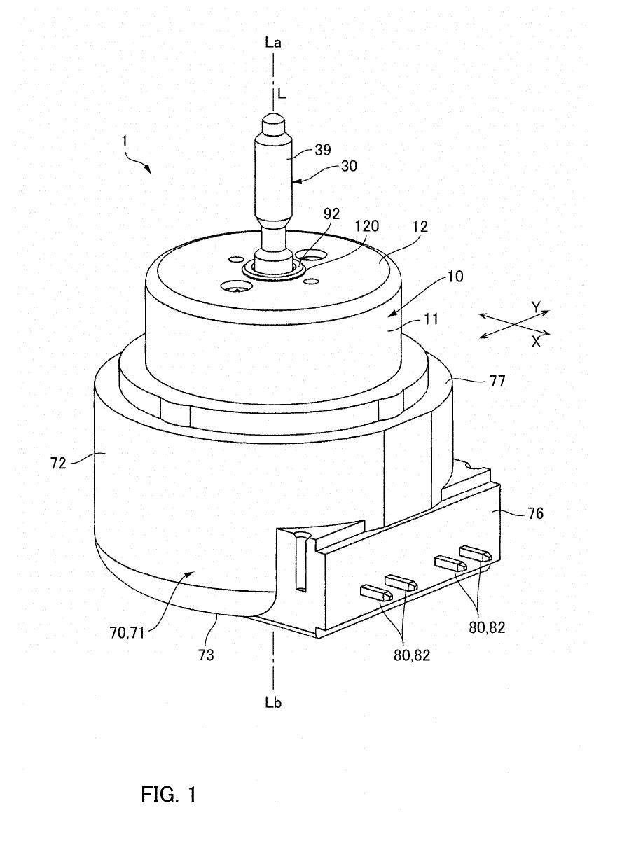

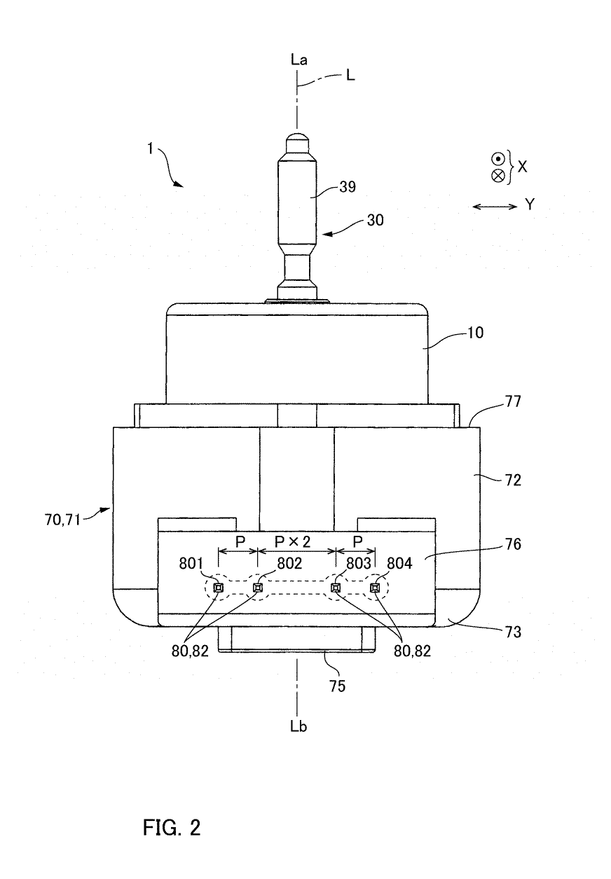

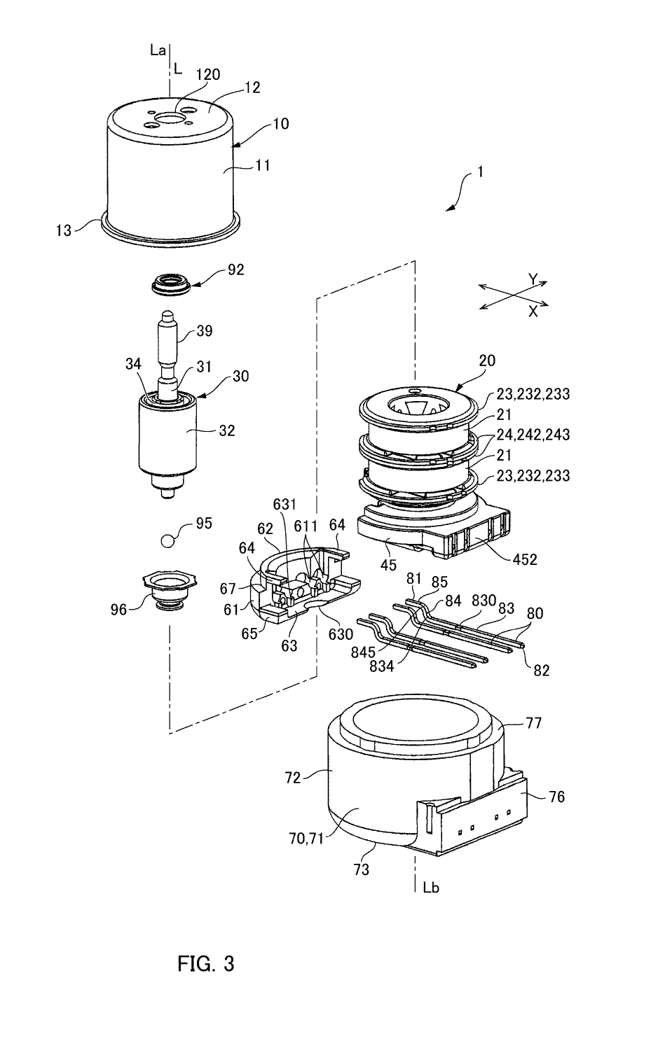

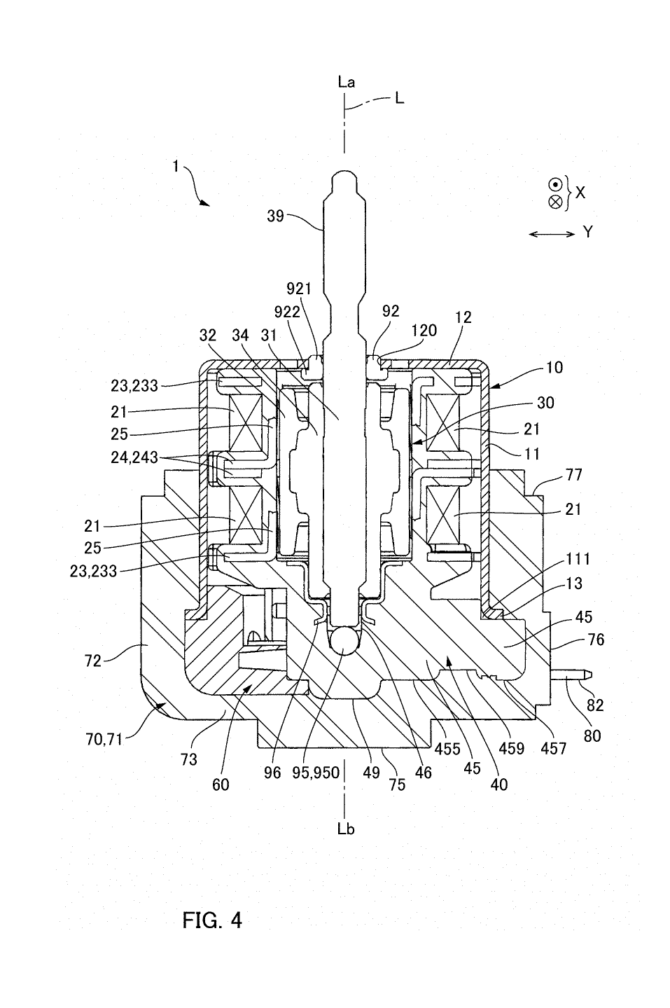

FIG. 1 is a perspective view showing a motor 1 to which at least an embodiment of the present invention is applied. FIG. 2 is a front view showing the motor 1 in FIG. 1 which is viewed in a direction that terminal pins 80 are protruded. FIG. 3 is an exploded perspective view showing the motor 1 in FIG. 1. FIG. 4 is a cross-sectional view showing the motor 1 in FIG. 1. A motor 1 shown in FIG. 1 is a stepping motor. As described below with reference to FIG. 2, FIG. 3, FIG. 4 and the like, the motor 1 includes a motor case 10, a stator 20, a rotor 30, a bobbin 40, a cover 60, a sealing resin body 70 and the like. The motor 1 is, for example, used as a drive source of an air-fuel mixture flow rate regulation valve (attaching object member) for a gasoline engine and is required with high airtightness in an attaching state. Therefore, the motor 1 is structured as a closed type motor.

The motor case 10 is formed in a cup shape by using magnetic metal such as iron and is provided with a peripheral wall 11 extended in a cylindrical tube shape in an axial line “L” direction and an end plate part 12 formed so as to close an opening of the peripheral wall 11 on one side “La” in the axial line “L” direction. The motor case 10 is formed with an opening part 111 on the other side “Lb” in the axial line “L” direction of the peripheral wall 11, and a flange part 13 protruded to an outer side in a radial direction is formed in an opening edge of the opening part 111.

The stator 20 is a tube-shaped body which is disposed in an inside of the motor case 10 and includes coils 21, a bobbin 40, yokes 23 (outer stator core) and yokes 24 (inner stator core). Each of the yokes 23 and 24 is a circular ring-shaped plate member made of metal and is formed with a plurality of pole teeth 25 at its inner peripheral edge which are bent in the axial line “L” direction at equal intervals in a circumferential direction. The yokes 23 and 24 are disposed facing each other so that respective pole teeth 25 are alternately arranged in the circumferential direction, and two sets of the yokes 23 and 24, as a pair, are disposed in the axial line “L” direction.

The bobbin 40 is a resin molding which is structured so that the yokes 23 and 24 are molded with a synthetic resin 41, and the bobbin 40 is structured by performing insert injection molding in a die in a state that the yokes 23 and 24 are inserted in the die. The synthetic resin 41 covers portions of the yokes 23 and 24 except outer peripheral parts 232 and 242 and inner peripheral faces of the pole teeth 25, and spaces in which the coils 21 are wound are structured between portions (flange part 41) overlapping with the circular ring-shaped parts 233 and 243 of the yokes 23 and 24. The stator 20 structured as described above is disposed so that the outer peripheral parts 232 and 242 of the yokes 23 and 24 are partly contacted with the peripheral wall 11 of the motor case 10.

A terminal block 45 is integrally formed at an end part of the bobbin 40 on the other side “Lb” in the axial line “L” direction, and an end part (flange part 13) of the motor case 10 on the other side “Lb” in the axial line “L” direction is abutted with the terminal block 45. A plurality of terminal pins 80 extended in a first direction “X” perpendicular to the axial line “L” direction is held by the terminal block 45 so as to be disposed parallel in a second direction “Y” perpendicular to the axial line “L” direction and the first direction “X”. A first end part 81 for connecting a coil wire which is one end of the terminal pin 80 is protruded from one side face 451 in the first direction “X” of the terminal block 45, and the first end part 81 is covered by the cover 60 fixed to the bobbin 40 in a state that an end part (not shown) of a coil wire structuring the coil 21 is connected by welding, soldering or the like. In this state, the opening part 111 of the motor case 10 is closed by the terminal block 45 and the cover 60. A second end part 82 for external connection which is the other end of the terminal pin 80 is protruded from the other side face 452 in the first direction “X” of the terminal block 45 and is used for electrical connection with the outside.

A bearing hole 46 which is recessed to the other side “Lb” in the axial line “L” direction is formed in a portion located on one side “La” in the axial line “L” direction of the terminal block 45. A tube-shaped bearing member 96 is disposed on an inner side of the bearing hole 46, and the bearing member 96 supports an outer peripheral face of a rotation shaft 31. A thrust support part 95 structured of a metal spherical body 950 is disposed in a bottom part of the bearing hole 46, and the thrust support part 95 supports an end part 310 on the other side “Lb” in the axial line “L” direction of the rotation shaft 31 described below from the other side “Lb” in the axial line “L” direction. In this embodiment, a protruded part 49 protruded to the other side “Lb” in the axial line “L” direction is formed at a position overlapping with the bearing hole 46 (position where the axial line “L” is passed) when viewed in the axial line “L” direction. As a result, a thickness overlapping with the bearing hole 46 is increased by the protruded part 49.

The rotor 30 includes the rotation shaft 31 extended in the axial line “L” direction and a permanent magnet 32 in a cylindrical tube shape which is fixed to an outer peripheral face of the rotation shaft 31 through a sleeve 34. An “N”-pole and an “S”-pole are alternately magnetized on an outer peripheral face of the permanent magnet 32 in a circumferential direction. Pole teeth 25 of the stator 20 face the permanent magnet 32 on an outer side in the radial direction.

An end plate part 12 of the motor case 10 is formed with a hole 120, and a part of the rotation shaft 31 is protruded through the hole 120 toward one side “La” in the axial line “L” direction. In this embodiment, a portion of the rotation shaft 31 which is protruded through the end plate part 12 of the motor case 10 is formed with an output shaft 39 where a spiral groove (not shown) is formed. Therefore, a valve body or the like can be linearly driven by rotation of the output shaft 39. A bearing 92 is held in the hole 120 formed in the end plate part 12 of the motor case 10. The bearing 92 is provided with a tube part 921 which rotatably supports an outer peripheral face of the rotation shaft 31, and a diameter enlarged part 922 which is enlarged from an end part of the tube part 921 on the other side “Lb” in the axial line “L” direction toward an outer side in the radial direction. The diameter enlarged part 922 is fixed in a state that the diameter enlarged part 922 is abutted with the end plate part 12 from the other side “Lb” in the axial line “L” direction.

In the motor 1 structured as described above, the opening part 111 in the axial line “L” direction of the motor case 10 is closed by the terminal block 45 integrally formed with the bobbin 40 and the cover 60 and, in this state, the terminal block 45, the cover 60 and an end part in the axial line “L” direction of the motor case 10 are covered by the sealing resin body 70. The sealing resin body 70 is provided with a bottom part 73 which covers the terminal block 45 and the cover 60 from the other side “Lb” in the axial line “L” direction and a body part 72 which covers side faces of the terminal block 45, the cover 60 and the motor case 10. The bottom part 73 is formed with a thick wall part 75, which is overlapped with the protruded part 49 of the terminal block 45 when viewed in the axial line “L” direction, so as to protrude to the other side “Lb” in the axial line “L” direction over a region larger than the protruded part 49. Further, the second end parts 82 of the terminal pins 80 are protruded from a wall face 76 of the sealing resin body 70. Therefore, a connector housing (not shown) is provided so as to surround a portion of the sealing resin body 70 where the terminal pins 80 are disposed and a connector (not shown) is connected with the terminal pins 80.

The sealing resin body 70 is a resin portion 71 which is formed so as to cover the terminal block 45, the cover 60 and the end part in the axial line “L” direction of the motor case 10 in a final stage of an assembly process, and the resin portion 71 is made of thermoplastic resin or thermosetting resin. In this embodiment, the resin portion 71 is made of thermoplastic resin such as polybutylene terephthalate (PBT). The sealing resin body 70 is firmly fixed to the motor case 10 in a state that the opening part 111 and the like of the motor case 10 is completely sealed. In this state, the motor case 10 is set in a state that most of the motor case 10 except a portion located on the other side “Lb” in the axial line “L” direction is exposed. Therefore, heat generated by the coils 21 can be efficiently dissipated outside through the metal motor case 10. Accordingly, insulation failure, thermal deformation of the respective members, thermal demagnetization of the permanent magnet 32 and the like due to melting of an insulating layer of the coil 21 can be suppressed. Further, a portion covered by the resin is reduced and thus the diameter, the weight and the cost can be reduced.

A face of the body part 72 of the sealing resin body 70 which faces one side “La” in the axial line “L” direction of the motor case 10 is formed to be a flange face 77 for attaching to an air-fuel mixture flow rate regulation valve. The flange face 77 is formed to be a flat face perpendicular to the axial direction of the motor case 10. The motor case 10 is, for example, inserted into an opening part of the air-fuel mixture flow rate regulation valve and the flange face 77 is closely contacted with an attaching face in a flat face shape provided at a periphery of the opening part and thereby airtightness is held through a seal member such as an O-ring.

### Structure of Terminal Pin 80, Terminal Block 45 and the like

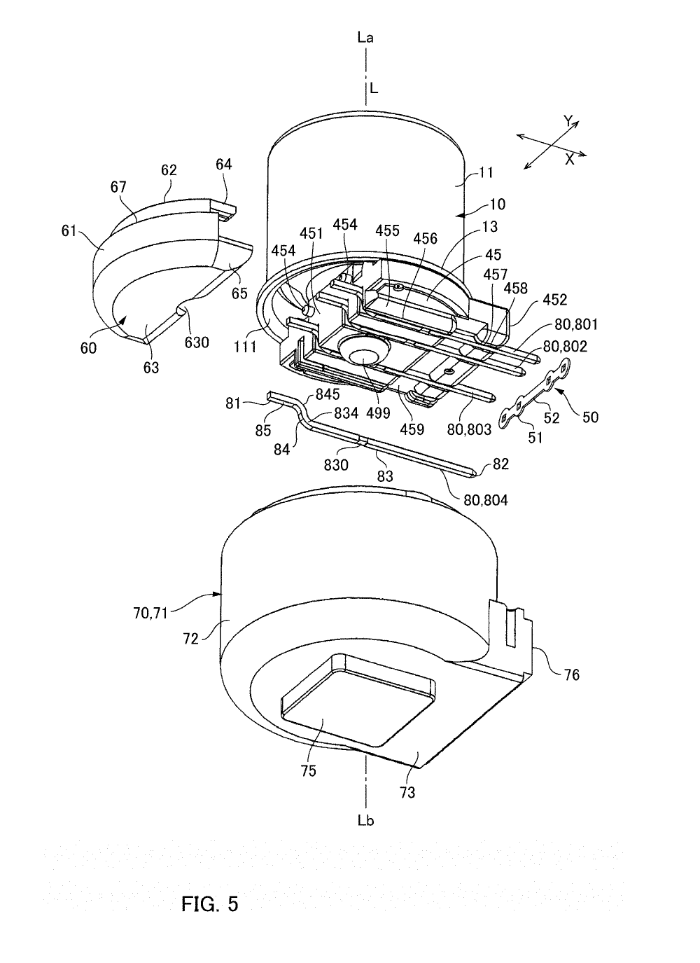

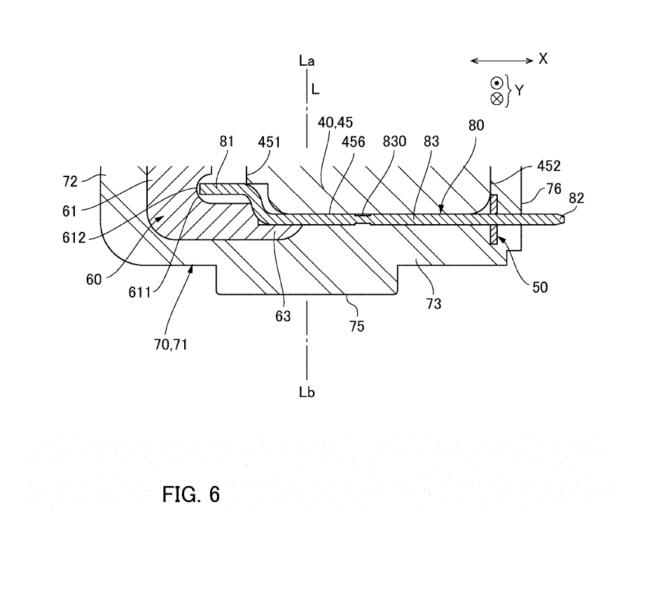

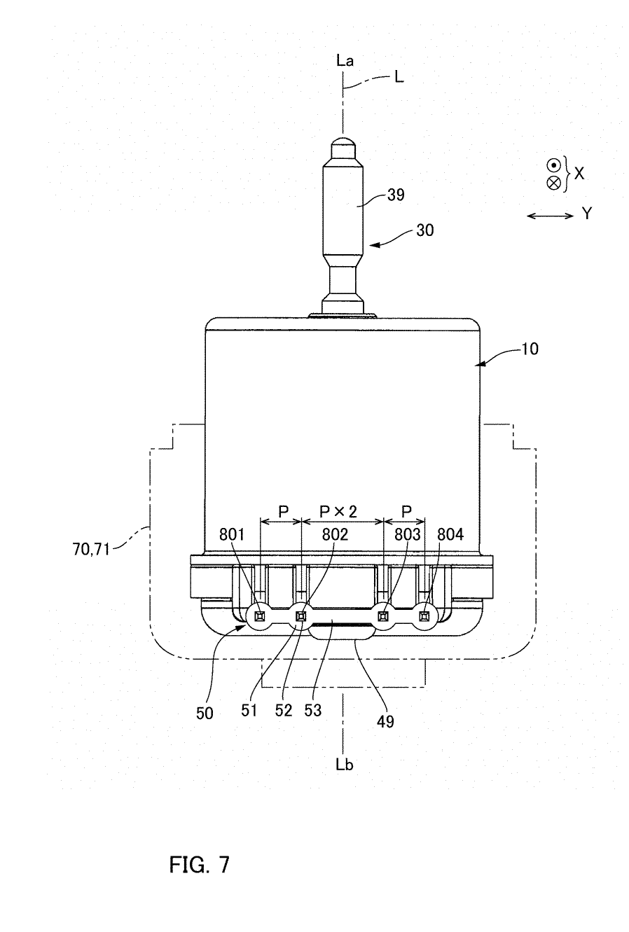

FIG. 5 is an explanatory view showing the terminal block 45 and the like shown in FIG. 4 viewed from the other side “Lb” in the axial line “L” direction, and the output shaft 39 is not shown in FIG. 5. FIG. 6 is a cross-sectional view showing the terminal block 45 and the like shown in FIG. 4 which are cut along the terminal pin 80. FIG. 7 is a front view showing the terminal block 45 shown in FIG. 4 which is viewed from a side of the second end part 82 of the terminal pin 80 and shows a state before the sealing resin body 70 is formed.

As shown in FIG. 5 and FIG. 6, the terminal pin 80 is a metal rectangular bar and, in this embodiment, the terminal pin 80 has a cross section of a quadrangular shape. The terminal pin 80 is provided with a first portion 83 linearly extended from a midway portion in the first direction “X” to the second end part 82, a second portion 84 which is bent from an end part on a side of the first end part 81 of the first portion 83 and is extended toward one side “La” in the axial line “L” direction, and a third portion 85 extended from an end part of the second portion 84 on one side “La” in the axial line “L” direction to the first end part 81. Therefore, the terminal pin 80 is provided with two bent parts 834 and 845. The first portion 83 is formed with a crushed part 830 which is formed by partly crushing the terminal pin 80. The crushed part 830 is, for example, worked by a press.

Corresponding to the structure of the terminal pin 80, a first terminal holding part 455 is formed at a center portion of the terminal block 45 where the axial line “L” is passed so as to protrude to the other side “Lb” in the axial line “L” direction and hold the first portion 83 of the terminal pin 80. A side face 451 of the terminal block 45 is structured by a side face of the first terminal holding part 455 on a side where the first end part 81 is located in the first direction “X”. Further, a second terminal holding part 457 which is protruded to the other side “Lb” in the axial line “L” direction and holds the first portion 83 is formed in the terminal block 45 at a position separated from the first terminal holding part 455 on a side where the second end part 82 is located. A side face 452 of the terminal block 45 is structured of a side face of the second terminal holding part 457 on a side where the second end part 82 is located in the first direction “X”. The first terminal holding part 455 is formed over a wide area in the first direction “X” and the second terminal holding part 457 is a projection part extended in the second direction “Y”. A recessed part 459 which is recessed to one side “La” in the axial line “L” direction is provided between the first terminal holding part 455 and the second terminal holding part 457.

A plurality of grooves 456 which hold the first portions 83 on their inner sides is provided on a face of the first terminal holding part 455 on the other side “Lb” in the axial line “L” direction so as to be extended in the first direction “X” and parallel in the second direction “Y”. The groove 456 is extended to the side face 451 and the second portion 84 of the terminal pin 80 is also held by the groove 456. In this embodiment, the crushed part 830 is formed in the first portion 83 and a partly projected portion formed when crushing work is performed bites into an inner face of the groove 456. Therefore, the terminal pin 80 can be temporarily fixed to an inner side of the groove 456. Further, a plurality of grooves 458 which hold the first portions 83 on their inner sides is provided on a face of the second terminal holding part 457 on the other side “Lb” in the axial line “L” direction so as to be on the extended lines of the grooves 456 and parallel in the second direction “Y”.

In this embodiment, the protruded part 49 is formed at a center of the terminal block 45 (position where the axial line “L” is passed) and thus, the grooves 456 and the terminal pins 80 are disposed so as to avoid the protruded part 49. More specifically, the grooves 456 and 458 and the terminal pins 80 are disposed in four rows in the second direction “Y”. In this case, a distance between the second and the third grooves 456 and 458 and the terminal pins 80 in the second direction “Y” is wider than a distance between the first and the second grooves 456 and 458 and the terminal pins 80 in the second direction “Y”, and wider than a distance between the third and the fourth grooves 456 and 458 and the terminal pins 80 in the second direction “Y”. The protruded part 49 is formed between the second and the third grooves 456 and 458 and the terminal pins 80 in the second direction “Y”.

In this embodiment, as shown in FIG. 2 and FIG. 7, in the terminal pins 80, a pitch (distance) between the first terminal pin 801 and the second terminal pin 802 in the second direction “Y” and a pitch (distance) between the third terminal pin 803 and the fourth terminal pin 804 in the second direction “Y” are “P”. On the other hand, a pitch (distance) between the second terminal pin 802 and the third terminal pin 803 in the second direction “Y” is “P×2”. In other words, it is equivalent that the third terminal pin is omitted in the structure that five terminal pins 80 are arranged at equal pitches in the second direction “Y”. Therefore, a structure may be adopted that a connector for five terminals (not shown) is connected with the second end parts 82 and a center terminal of the connector is utilized as a dummy terminal.

### Structure of Cover 60

As shown in FIG. 3, FIG. 4 and FIG. 5, the cover 60 is a resin molding, which is provided with a facing part 61 facing the side face 451 of the terminal block 45, a protruded part 62 protruded from an end part of the facing part 61 on one side “La” in the axial line “L” direction to one side “La” in the axial line “L” direction, and a plate part 63 protruded from an end part of the facing part 61 on the other side “Lb” in the axial line “L” direction toward the terminal block 45. Each of the facing part 61 and the protruded part 62 is curved in a circular arc shape along the flange part 13 of the motor case 10. Further, the protruded part 62 is located on an inner side in the radial direction with respect to the facing part 61. Thick wall parts 65 protruded toward both sides in the second direction “Y” of the terminal block 45 are formed at both end parts in the second direction “Y” of the plate part 63.

Therefore, when the cover 60 is pushed to a side of the terminal block 45 so that the protruded part 62 is fitted to an inner side of the opening part 111 of the motor case 10, the first terminal holding part 455 of the terminal block 45 is set in a state that the first terminal holding part 455 is sandwiched by the thick wall parts 65 of the cover 60. Further, the flange part 13 of the motor case 10 is abutted with the step part 67 of the cover 60 and the protruded part 62 is disposed along the inner face of the peripheral wall 11 of the motor case 10. In this manner, the cover 60 is positioned by the motor case 10.

A wall face of the facing part 61 facing the side face 451 is formed with recessed parts 611 into which the first end parts 81 of the four terminal pins 80 are respectively entered. Therefore, as shown in FIG. 6, the first end part 81 is prevented from abutting with an inner wall 612 of the recessed part 611 facing the first end part 81.

The plate part 63 of the cover 60 is overlapped with the terminal block 45 from the other side “Lb” in the axial line “L” direction, and the plate part 63 is overlapped with a part of the first portion 83 of each of the terminal pins 80 (portion on the first end part 81 side with respect to the crushed part 830). In this case, a cut-out part 630 of the plate part 63 is fitted to the protruded part 49. In this state, the other portion of the terminal pin 80 (portion of the crushed part 830 and the like of the first portion 83) is set in an exposed state from the cover 60. Therefore, when the sealing resin body 70 is provided, the entire portion of the terminal pin 80 exposed from the cover 60 is covered by the sealing resin body 70 except the vicinity of the second end part 82. In this case, in the recessed part 459 formed between the first terminal holding part 455 and the second terminal holding part 457, the sealing resin body 70 also covers the side faces of the terminal pin 80. In this embodiment, the plate part 63 of the cover 60 is formed with a plurality of plate parts 631, and the plate parts 631 are fitted to the grooves 458 and overlapped with the terminal pins 80. Therefore, the plate part 631 supports the terminal pin 80 and, when the sealing resin body 70 is to be molded, resin is restrained from passing through around the terminal pin 80 to be flowed into an inner side of the cover 60.

### Structure of Seal Member 50

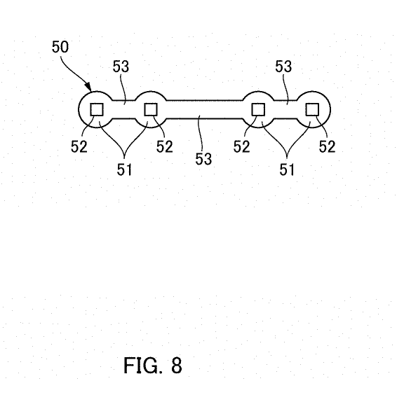

FIG. 8 is an explanatory view showing a seal member 50 which is used in the motor 1 shown in FIG. 1. As shown in FIG. 6, in the motor 1 in this embodiment, a seal member 50 is attached to respective portions of the plurality of the terminal pins 80, which are protruded from the terminal block 45 on a side of the second end part 82 and at a position located between the terminal block 45 and the wall face 76 of the sealing resin body 70. The seal member 50 seals spaces between the plurality of the terminal pins 80 and the sealing resin body 70. As shown in FIG. 6, the seal member 50 is formed in a sheet shape and is buried in the sealing resin body 70. In this embodiment, the seal member 50 is disposed along the side face 452 on the second end part 82 side of the terminal block 45 and thus, the entire seal member 50 is buried in the sealing resin body 70 and is not exposed outside.

As shown in FIG. 8, the seal member 50 is provided with a plurality of seal parts 51 which are attached to the respective terminal pins 80 and the seal parts 51 adjacent to each other are connected with each other through connecting parts 53. The seal part 51 is formed with a hole 52 having a size and a shape corresponding to the cross-sectional shape of the terminal pin 80, and the terminal pin 80 is penetrated through the hole 52. In this embodiment, the terminal pin 80 has a quadrangular cross-section and thus, the hole 52 is also formed in a quadrangular shape. Further, the four holes 52 are respectively provided at a pitch (interval) corresponding to the terminal pitch described with reference to FIG. 2 and FIG. 7.

In this embodiment, the seal member 50 has elasticity. In this embodiment, the seal member 50 is a sheet made of rubber. Therefore, when the seal member 50 is taken off from the terminal pins 80, a size of the hole 52 to which the terminal pin 80 is fitted is smaller than a thickness (size) of the terminal pin 80. Accordingly, when the terminal pin 80 is penetrated through the hole 52, the hole 52 is expanded and thus high adhesiveness between the terminal pin 80 and an inner edge of the hole 52 is attained.

### Manufacturing Method of Motor 1

In a manufacturing method of the motor 1 in this embodiment, as shown in FIG. 7, after the motor case 10, the terminal pins 80 and the cover 60 are attached to the terminal block 45, in a step for forming the sealing resin body 70, resin molding is performed in a state that the seal member 50 is attached to the portions of the respective terminal pins 80 protruded from the terminal block 45 on the side of the second end parts 82 to form the sealing resin body 70. In this case, the seal member 50 is made of rubber and thus, the seal member 50 is softened by temperature (by heated) when the sealing resin body 70 is to be molded. Therefore, high adhesiveness between the seal member 50 and the terminal pin 80, and high adhesiveness between the seal member 50 and the sealing resin body 70 can be attained. Further, in a case that the sealing resin body 70 is thermosetting resin, the thermosetting resin is hardened in an adhesively contacted state with the seal member 50 and thus the adhesiveness between the seal member 50 and the sealing resin body 70 is high.

### Principal Effects in this Embodiment

As described above, in the motor 1 in this embodiment, the opening part 111 of the motor case 10 is closed by the terminal block 45 which holds the terminal pins 80 and the cover 60 which covers the first end parts 81 of the terminal pins 80 and, in addition, the sealing resin body 70 is provided which covers the terminal block 45, the cover 60 and the peripheral wall 11 (side face) of the motor case 10. Therefore, entering of moisture into an inner side of the motor case 10 can be restrained. Further, the seal member 50 is attached to the portions of the respective terminal pins 80 which are protruded from the terminal block 45 on the side of the second end parts 82 between the terminal block 45 and the wall face 76 of the sealing resin body 70, and spaces between the terminal pins 80 and the sealing resin body 70 are sealed by the seal member 50. Therefore, high airtightness between the terminal pins 80 and the sealing resin body 70 is attained and thus moisture can be surely restrained from entering into an inner side of the cover 60 through spaces between the terminal pins 80 and the sealing resin body 70. Further, entering of moisture into an inner side of the motor case 10 from the opening part 111 through spaces between the terminal pins 80 and the sealing resin body 70 can be also surely restrained. Accordingly, reliability of the motor 1 can be enhanced without using a waterproof connector.

Further, in the seal member 50, a plurality of the seal parts 51 attached to the respective terminal pins 80 is connected with each other and thus spaces between a plurality of the terminal pins 80 and the sealing resin body 70 can be sealed by one seal member 50. Therefore, the cost can be reduced.

The seal member 50 is made of rubber and has elasticity. Therefore, high adhesiveness between the terminal pins 80 and the seal member 50 is attained and thus, high airtightness between the sealing resin body 70 and the terminal pins 80 is attained. Further, when the seal member 50 is taken off from the terminal pins 80, a size of the hole 52 into which the terminal pin 80 is fitted is smaller than a thickness (size) of the terminal pin 80. Therefore, since the adhesiveness between the terminal pins 80 and the seal member 50 is high, high airtightness between the sealing resin body 70 and the terminal pins 80 is attained. Further, the seal member 50 is buried in the inside of the sealing resin body 70 and thus, a pressure is applied to the seal member 50 when the sealing resin body 70 is to be formed. Therefore, the adhesiveness of the seal member 50 to the terminal pins 80 and the adhesiveness of the seal member 50 with the sealing resin body 70 are high. In addition, the entire seal member 50 is buried in the inside of the sealing resin body 70 and thus, a pressure is applied to the entire seal member 50 when the sealing resin body 70 is to be formed. Therefore, the adhesiveness of the seal member 50 to the terminal pins 80 and the adhesiveness of the seal member 50 with the sealing resin body 70 are high. Accordingly, high airtightness between the sealing resin body 70 and the terminal pins 80 is attained.

Further, in this embodiment, the cover 60 covers parts of the portions of the terminal pins 80 located in the grooves 456 and the other parts (remaining parts) of the terminal pins 80 are covered by the sealing resin body 70. Therefore, the terminal pins 80 disposed in the grooves 456 are sealed by the sealing resin body 70 and thus, moisture can be surely restrained from passing through around the terminal pins 80 and entering to the inner side of the motor case 10 through the opening part 111.

Further, the sealing resin body 70 is reached around the terminal pins 80 in the recessed part 459 between the first terminal holding part 455 and the second terminal holding part 457. Therefore, the sealing resin body 70 is capable of appropriately sealing around the terminal pins 80. Accordingly, moisture can be surely restrained from passing through around the terminal pins 80 and entering to the inner side of the motor case 10 through the opening part 111.

The protruded part 49 is formed at the center of the terminal block 45 (position where the axial line “L” is passed, position overlapping with the bearing hole 46 when viewed in the axial line “L” direction) and the grooves 456 and the terminal pins 80 are disposed so as to avoid the protruded part 49. Therefore, even in a case that the terminal pins 80 are held by the grooves 456, a wall thickness of the entire terminal block 45 is not required to increase for increasing a wall thickness at the position overlapping with the bearing hole 46 and thus, a dimension in the axial line “L” direction of the motor 1 can be reduced.

Further, the bent parts 834 and 845 are provided between the first end part 81 with which a coil wire is connected and the portion of the terminal pin 80 held by the groove 456, and the second portion 84 between the bent part 834 and the bent part 845 is located in the groove 456. Therefore, a stress which is applied when a coil wire is connected with the first end part 81 is hard to be applied to the first portion 83 held by the groove 456. Accordingly, when a coil wire is connected with the first end part 81, the first portion 83 is hard to be come off from the groove 456.

### Another Embodiment

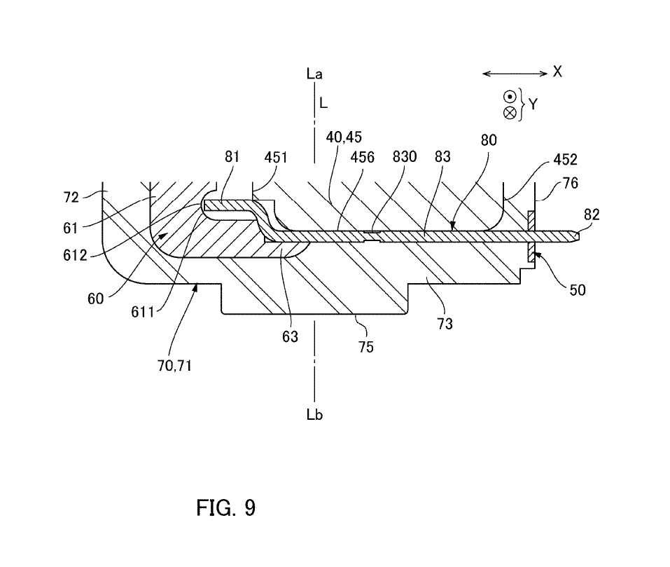

FIG. 9 is an explanatory view when a position of the seal member 50 is changed in the motor 1 shown in FIG. 1 and is a cross-sectional view in which the terminal block 45 and the like are cut along the terminal pin 80. In the embodiment described with reference to FIG. 1 through FIG. 8, the entire seal member 50 is buried in the sealing resin body 70. On the other hand, in this embodiment, as shown in FIG. 9, although the seal member 50 is buried in the sealing resin body 70, a part of the seal member 50 is exposed from the wall face 76. Even in this embodiment, spaces between a plurality of the terminal pins 80 and the sealing resin body 70 are sealed by the seal member 50. Therefore, high airtightness between the terminal pins 80 and the sealing resin body 70 is attained and thus moisture can be surely restrained from entering into an inner side of the cover 60 through spaces between the terminal pins 80 and the sealing resin body 70. Further, entering of moisture into an inner side of the motor case 10 from the opening part 111 through spaces between the terminal pins 80 and the sealing resin body 70 can be also surely restrained.

### Further Other Embodiments

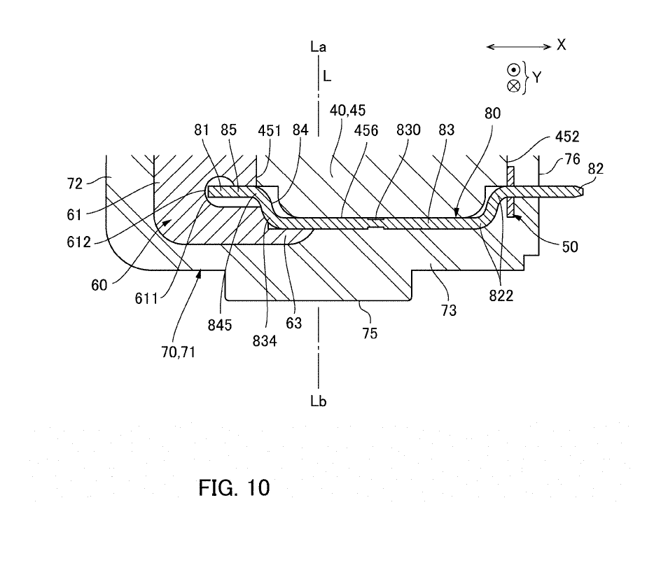

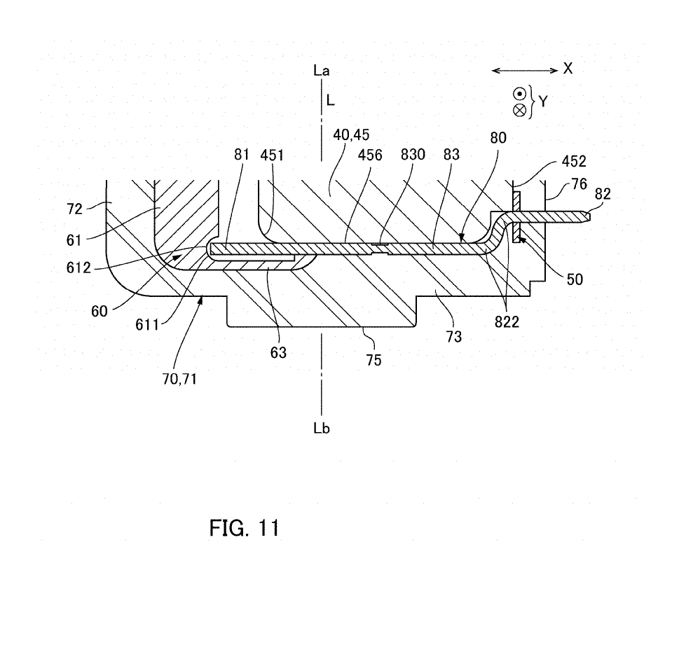

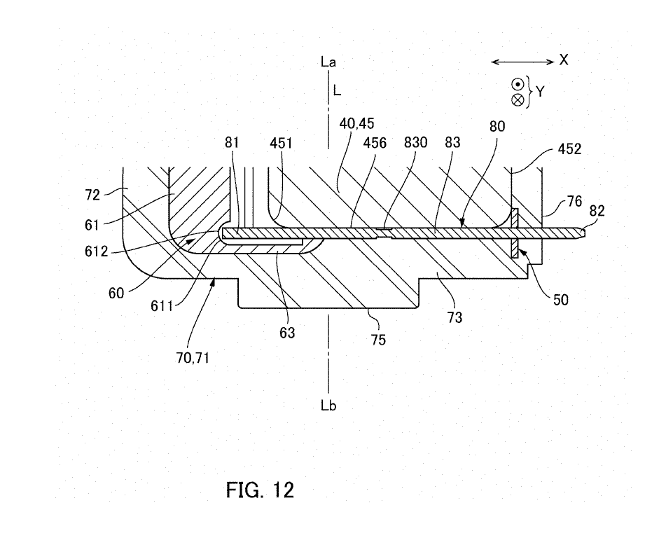

FIG. 10 is an explanatory view showing a first modified example of the terminal pin 80 which is used in the motor 1 shown in FIG. 1. FIG. 11 is an explanatory view showing a second modified example of the terminal pin 80 which is used in the motor 1 shown in FIG. 1. FIG. 12 is an explanatory view showing a third modified example of the terminal pin 80 which is used in the motor 1 shown in FIG. 1.

In the embodiment described with reference to FIG. 1 through FIG. 8, the bent parts 834 and 845 are provided on the first end part 81 side of the terminal pin 80. However, as shown in FIG. 10, at least an embodiment of the present invention may be applied to a structure that bent parts 822 are provided on the second end part 82 side and that the first end part 81 and the second end part 82 are located on one side “La” in the axial line “L” direction with respect to the first portion 83. Further, as shown in FIG. 11, at least an embodiment of the present invention may be applied to a structure that bent parts are not provided on the first end part 81 side and the only bent parts 822 are provided on the second end part 82 side and that the second end part 82 is located on one side “La” in the axial line “L” direction with respect to the first portion 83. Further, as shown in FIG. 12, at least an embodiment of the present invention may be applied to a structure that no bent part is provided on the first end part 81 side and the second end part 82 side and that the terminal pin 80 is extended linearly.

In the embodiments described above, the motor 1 is a stepping motor. However, at least an embodiment of the present invention may be applied to other types of motor.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a rotor comprising a permanent magnet;
a stator facing the permanent magnet;
a motor case which covers the rotor and the stator and comprises an end plate part at an end part on a first side in an axial direction;
a terminal block disposed on a second side in the axial direction of the motor case;
a plurality of terminal pins which are extended in a direction intersecting the axial direction, each of the terminal pins comprising a first end part for connecting with a coil wire at a first end and a second end part for connecting with an outside at a second end, and the first end part and the second end part being protruded from the terminal block;
a cover which is disposed so as to cover the first end part and closes an opening part of the motor case which opens on the second side in the axial direction together with the terminal block;
a sealing resin body which is provided so as to cover the terminal block and the cover from the second side in the axial direction and cover a side face of the motor case, and the sealing resin body comprising a wall face from which the second end part is protruded; and
a seal member which is attached to a portion of each of the terminal pins protruded from the terminal block on a side of the second end part between the terminal block and the wall face, wherein the seal member seals between the plurality of the terminal pins and the sealing resin body.

2. The motor according to claim 1, wherein the seal member is structured so that a plurality of seal parts respectively attached to the plurality of the terminal pins is connected with each other.

3. The motor according to claim 1, wherein the seal member has elasticity.

4. The motor according to claim 3, wherein the seal member is made of rubber.

5. The motor according to claim 3, wherein the seal member is structured so that, when the seal member is taken off from the terminal pin, a size of a hole into which the terminal pin is fitted is smaller than a thickness of the terminal pin.

6. The motor according to claim 1, wherein the seal member is buried in an inside of the sealing resin body.

7. The motor according to claim 6, wherein a whole of the seal member is buried in the inside of the sealing resin body.

8. The motor according to claim 1, wherein
the terminal block comprises a plurality of grooves each of which holds each of the terminal pins on an inner side of the groove on a face of the terminal block on the second side in the axial direction,
the cover covers a part of a portion of each of the terminal pins located in the groove from the second side in the axial direction, and
the sealing resin body covers a remaining part of the portion of each of the terminal pins located in the groove from the second side in the axial direction.

9. The motor according to claim 8, wherein the portion of the terminal pin located in the groove is formed with a crushed part.

10. A manufacturing method of a motor comprising a rotor comprising a permanent magnet; a stator facing the permanent magnet; a motor case which covers the rotor and the stator and comprises an end plate part at an end part on a first side in an axial direction; a terminal block disposed on a second side in the axial direction of the motor case; a plurality of terminal pins which are extended in a direction intersecting the axial direction, each of the terminal pins comprising a first end part for connecting with a coil wire at a first end and a second end part for connecting with an outside at a second end, and the first end part and the second end part being protruded from the terminal block; a cover which is disposed so as to cover the first end part and closes an opening part of the motor case which opens on the second side in the axial direction together with the terminal block; a sealing resin body which is provided so as to cover the terminal block and the cover from the second side in the axial direction and cover a side face of the motor case, and the sealing resin body comprising a wall face from which the second end part is protruded; and a seal member which is attached to a portion of each of the terminal pins protruded from the terminal block on a side of the second end part between the terminal block and the wall face, wherein the seal member seals between the plurality of the terminal pins and the sealing resin body, the manufacturing method comprising:
attaching the motor case, the terminal pins and the cover to the terminal block; and
after that, forming the sealing resin body;
wherein in a step for forming the sealing resin body, resin molding is performed in a state that the seal member is attached to the portion of each of the terminal pins which is protruded from the terminal block on the side of the second end part and thereby the sealing resin body is formed.
